(19) United States
(12) Patent Application Publication
(10) Pub. No.: US 2021/0248520 A1
(43) Pub. Date: Aug. 12, 2021

(54) TIMING OPTIMIZATION FOR TRANSITING USERS OF AN ON-DEMAND TRANSPORT SERVICE

(71) Applicant: Uber Technologies, Inc., San Francisco, CA (US)

(72) Inventors: Pavan Krishnamurthy, San Francisco, CA (US); Xinxi Chen, San Francisco, CA (US); Tanvi Surti, San Francisco, CA (US); Cinar Kilcioglu, San Francisco, CA (US); Sudharsan Vasudevan, San Francisco, CA (US); Eric Li, San Francisco, CA (US); Donald Stayner, San Francisco, CA (US)

(21) Appl. No.: 16/789,178

(22) Filed: Feb. 12, 2020

(51) Int. Cl. G06Q 10/02; G06Q 10/06; H04W 4/029; H04W 4/42; G06Q 50/30

(52) U.S. Cl. CPC G06Q 10/02; G06Q 10/06314; G06Q 50/30; H04W 4/42; H04W 4/029

(57) ABSTRACT

A computing system can communicate, over one or more networks, with computing devices of requesting users and transport providers of a transport service, and determine, based at least in part on location data from the computing devices of a cluster of the requesting users, that the cluster of requesting users is currently in transit on a third-party transit means. The computing system can then determine that a subset of the cluster will arrive at a common arrival location of the third-party transit means, and execute a timing optimization for the subset to determine, for each requesting user of the subset, an optimal time to transmit a transport request for an on-demand transport service at the common arrival location.

### BACKGROUND

Mass transport riders often require additional transport upon arriving at fixed stations to get them to their respective destinations. However, when popular stations experience a mass outflow of riders (e.g., from trains) that require additional transport, traffic congestion and confusion can result in increased delays.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example computing system implementing an on-demand coordinated transport service, in accordance with examples described herein;

FIG. 2 is a block diagram illustrating an example computing device executing one or more service applications for communicating with a computing system, according to examples described herein;

FIG. 3 is a flow chart describing an example method of coordinating transport for transit riders, according to various examples;

FIG. 4 is a flow chart describing an example method of predictive configuration of transport supply at transit egress areas, according to various examples; and

FIG. 5 is a block diagram that illustrates a computer system upon which examples described herein may be implemented.

### DETAILED DESCRIPTION

A computing system can implement on-demand transport services for a given region in which user intent from a cluster of transiting users is identified prior to the transiting users arriving at an arrival location. In certain examples, the computing system can monitor location and/or app-based utilization information from users to determine that a cluster of users is currently traveling on a common third-party transit means (e.g., a train, bus, ferry, plane, etc.). Commonly, riders of transit services require additional transport to their final destinations upon arriving at an arrival location (e.g., a train station, bus station, ferry terminal, etc.). These transit riders can utilize shared bicycles and scooters, taxis, on-demand transport (e.g., rideshare and carpool services), and the like to transport them from their respective arrival locations to their final destinations. However, transit riders are typically left to independently search for transport options upon arriving, often being left dealing with a significant inefficiency in transport servicing to each rider's final destination existing in such locations.

In certain implementations, the computing system can transmit a set of queries while the users are in-transit to determine each user's arrival location, transport preference, and/or final destination. In variations, the computing system can store a user profile indicating historical utilization information for each user. Using each user's historical utilization information, the computing system can infer the user's arrival location, final destination, and/or preferred mode of transport. The computing system can further monitor transport supply conditions at each arrival location of the third-party transit means and perform a timing optimization for each cluster of transit riders disembarking at each arrival location of the third-party transit means.

In performing the timing optimization, the computing system can determine a total number of transiting riders that will disembark at a common arrival location. For each of these transiting riders, the computing system can determine a preferred mode of transport or multiple permitted modes of transport (e.g., carpool, standard rideshare, scooter, bicycle, etc.) to transport each rider to a respective final destination. The computing system can further determine each rider's final destination and the transport supply conditions for each mode of transport. In various implementations, the transiting riders have the option of selecting from multiple transport options, such as a standard rideshare option, a luxury vehicle option, a carpool option, a walk-pool option (e.g., a lower cost option to the carpool option, in which the user walks a certain distance to rendezvous with a carpool driver), a high-capacity vehicle option, and personal transport options (e.g., shared scooters and/or bicycles).

Once the transport preferences and final destinations of each transiting user are known, the computing system can monitor an estimated time of arrival of the third-party transport means to the common arrival location, and for each user, determine an optimal request time for each user to transmit a ride request. In doing so, the computing system can increase transport efficiency for the riders, the transport providers, and through the arrival location (e.g., minimize overall wait times and/or minimize costs for all participants). The computing system may therefore passively monitor the transport supply conditions at each arrival location, and provide each user with a request notification that indicates a most optimal time to submit a transport request, such that a transport coordination system can receive the request and match the transiting rider in a globally optimized manner with respect to the arrival location. For example, the transport coordination system can determine each transiting user's intent to utilize the transport service at the arrival location and transmit respective transport invitations to selected drivers at specified times to achieve an overall cost reduction for matching users and drivers at the arrival location. In certain scenarios, the computing system can further account for walk times for the transiting riders to a pickup area of the arrival location, and in certain situations, the riders' location within the transit means (e.g., whether the location within a train will involve a longer walk to a pickup area).

In certain implementations, the computing system can automatically transmit the transport request at the optimal time for each of the transiting riders (e.g., when authorizations permit). Whether instigated by the transiting rider or automatically configured by the computing system, the timing optimization described herein may be performed for each third-party transit means, and in certain scenarios, multiple arrival locations of the third-party transit means. It is contemplated that the timing optimization can leverage the early knowledge of rider intent to utilize the on-demand transport well prior to disembarking from third-party transportation in order to determine the most optimal request time for each rider. With advanced knowledge of rider intent, transport preference, and final destination, the computing system can further monitor whether transport supply conditions for a particular transport option improve in terms of minimizing wait times and/or costs (e.g., for both drivers and riders). Accordingly, the timing optimization performed by the computing system can be dynamic, such that the optimal request time for each rider is determined and/or transmitted at specified times such that transport providers at the arrival location are coordinated to most efficiently rendezvous with the riders upon disembarking. In doing so, the computing system can impose wait times on itself for certain transport options prior to determining the most optimal request times for those select transport options.

In certain examples, the computing system can be triggered to execute the timing optimization for a cluster of users riding a common transit means and having a common arrival location when the number of users in the cluster exceeds a certain threshold (e.g., forty). In such examples, the computing system can disregard lower volume arrival locations and focus primarily on high traffic, high volume arrival locations and times, which typically involve more congestion and would benefit the most from the timing optimizations described herein.

Among other benefits, examples described herein achieve a technical solution to current technical problems experienced in the field of remote, on-demand transport services. In particular, the computing system described herein can remotely monitor transit means—such as trains, buses, planes, ferries, and the like—determine destination intentions of riders of the transit means while in-transit to an egress location, pre-configure and coordinate on-demand transport modes for the riders when they disembark from the third-party transit means, and perform timing optimizations for the riders such that traffic and wait times at egress locations are minimized. In doing so, the computing system described herein can anticipate transport demand at egress locations, such as train stations, bus stations, airports, ferry terminals, and the like, in order to provide seamless transport for transit riders and reduce congestion at such egress locations.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

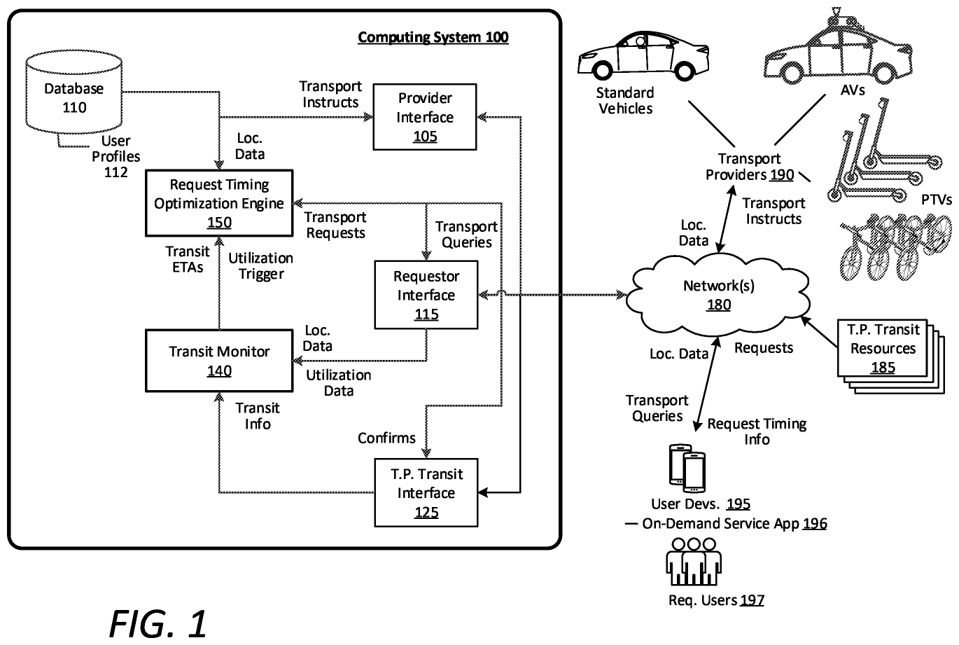

FIG. 1 is a block diagram illustrating an example computing system implementing an on-demand coordinated transport service, in accordance with examples described herein. In various examples, the computing system 100 can include a requestor interface 115 to communicate, over one or more networks 180, with computing devices 195 of requesting users 197. For example, the computing system 100 can communicate via an executing on-demand service application 196 on the computing devices 195 of the users 197 to enable the users 197 to configure and transmit transport requests for on-demand transport services. In various examples, the computing devices 195 of the users 197 can also transmit location data to the computing system 100 to enable the computing system 100 to perform timing optimizations for requesting transport at a particular drop-off location of a third-party transit means.

As provided herein, a third-party transit means can comprise transportation provided by an entity other than the computing system 100 implementing on-demand transport services. Such transit means can correspond to public or private mass transit options, such as buses, trains, subways, ferries, airplanes, and the like. According to various examples, the computing system 100 can include a transit monitor 140 that monitors transit information, such as the dynamic locations, trajectory, velocity, and any delay information of the third-party transit means. Such information can be processed by the transit monitor 140 to generate transit ETAs for each transit means to each stopping location where users 197 will disembark, such as a train station, airport terminal, ferry terminal, and the like.

The computing system 100 can also include a provider interface 105 to communicate, over the one or more networks 180, with computing devices corresponding to various transport providers 190 that are available to provide transport services for the requesting users 197 on demand. In various examples, the communications with the various transport providers 190 can correspond to transport invitations to drivers of standard human-driven vehicles, transport instructions to autonomous vehicles, instructions to drivers of high capacity distribution vehicles to drop off or pick up personal transport vehicles (e.g., manual bicycles, hybrid bicycles, electric scooters, etc.), and/or lock and unlock commands to the personal transport vehicles (e.g., for authentication by a particular user 197 to unlock a bicycle or scooter).

In various implementations described herein, the computing system 100 can act as a mediator or optimized timing service separate from the on-demand transport coordination system that actually matches users 197 with transport providers 190. As such, the computing system 100 can identify the marketplace supply conditions at a particular arrival location (e.g., the number and availability of transport providers 190 at a popular train station), and determine the optimal times, for each transiting user, that a transport request should be transmitted to the on-demand transport coordination system such that the arrival times of the transport providers 190 and the arrival time of the third-party transit means substantially align. As a basic example, a nearest carpool driver may be twenty minutes away from the arrival location. One or more transiting users 197 that select the carpool ride service as a preferred option will receive an early notification (e.g., twenty minutes prior to arrival) to transmit a carpool transport request such that a carpool driver will be arriving at the arrival location at substantially the same time as the transiting user(s) 197.

Given a cluster of users 197 (e.g., more than one-hundred riders) on a third-party transit means that will arrive at a common arrival location (e.g., a train station), the computing system 100 can determine the transport supply marketplace conditions at the arrival location and execute a global timing optimization that can output an optimal time for each user 197 to transmit a transport request for that user's selected transport option to the on-demand transport coordination system. In doing so, the computing system 100 can seek to maximize the flow of arriving vehicles and pick-ups at the common arrival location while minimizing the wait times of the drivers and users 197 at the arrival location.

According to examples described herein, the computing system 100 can further include a third-party transit interface 125 to communicate, over the one or more networks 180, with third-party transit resources 185 to determine schedules and transit information of entities operating or otherwise monitoring third-party transit means, such as trains, buses, flights, boat ferries, and the like. Such transit information can further provide established schedules, routes, and dynamic information, such as delays, construction information, detours, cancelations, etc. to the transit monitor 140 in order to enable the computing system 100 to plan and configure transport supply at egress locations of the third-party transit means. As described herein, these egress locations can comprise bus stops, bus stations, train stations, airport terminals, ferry terminals, and the like.

According to various examples, the transit monitor 140 can access or otherwise receives the transit information from the third-party transit resources 185 to determine the transit schedules of the third-party transit means throughout a particular region (e.g., a metropolitan area for which the computing system 100 coordinates on-demand transport, such as the Washington D.C.-Baltimore metroplex). In certain implementations, the transit monitor 140 can further receive the location data from the computing devices 195 of the requesting users 197 to, for example, determine whether a cluster of users 197 are currently riding on a third-party transit means, such as a train, and dynamically determine the ETA of the train to any given station at which a cluster of users 197 will disembark.

In one example, the transit monitor 140 can further receive utilization data from the computing devices 195 of the requesting users 197. The utilization data can correspond to the user's current interactions with the executing service application 196, which can indicate a future desire to request transport at an arrival location of the third-party transit means. Specifically, empirical analysis of historical utilization data of users indicates a high conversion rate (e.g., 94%) of users 197 opening the service application 196 on their computing devices 195 and requesting transport, versus users 197 opening the service application 196 and not requesting transport within a certain amount of time (e.g., fifteen minutes). Accordingly, the utilization data from the service application 196 executing on the computing devices 195 of transiting users 197 can provide the transit monitor 140 with a relatively high probability that any user 197 interacting with the service application 196 while in transit will most likely request transport at an arrival location of the third-party transit means (e.g., a train station).

In certain implementations, when the transit monitor 140 identifies a cluster of users 197 currently in transit on a third-party transit means, the transit monitor 140 can further monitor the user devices 195 for utilization data indicating any user's interactions with the service application 196. In some aspects, when utilization of the service application 196 is detected, the transmit monitor 140 can transmit a utilization trigger to a request timing optimization engine 150 of the computing system 100. In further aspects, the transit monitor 140 can process the location data from the computing devices 195 of the cluster of transiting users 197 to update or confirm, at any time, an ETA of the third-party transit means (e.g., a train) to any particular arrival location (e.g., a train station), and transmit the updated ETA information to the timing optimization engine 150.

In one or more examples, upon receiving the utilization trigger from the transit monitor 140, the timing optimization engine 150 can identify the transiting users 197 currently utilizing the service application 196, and transmit a set of transport queries to the user's computing device 195 (e.g., as push notifications via the service application 196) to determine a final destination of the user 197, an arrival location of the third-party transit means at which the user 197 will disembark, and/or a transport preference for transporting the user 197 from the arrival location to the final destination (e.g., a private car, luxury vehicle, carpool, or personal transport). It is contemplated that the timing optimization engine 150 can perform such queries for each transiting user 197 of any third-party transit means throughout the transport service region, in order to perform the cost and/or timing optimization techniques described herein.

It is further contemplated that one or more of the queried notifications can instead be inferred by the timing optimization engine 150. In particular, the computing system 100 can include a database 110 storing user profiles 112 for the requesting users 197. In various applications, the user profile 112 for any particular user 197 can comprise historical utilization data corresponding to the user's historical usage of the on-demand transport service. These data can include common destinations of the user 197 (e.g., a work location, home location, train station, bus station, airport, ferry terminal, etc.), common pick-up locations, commonly used transport services (e.g., scooters, bicycles, standard rideshare, carpool rideshare, etc.), and any default permissions or preferences of the user 197.

In some aspects, the permissions or preferences of the user 197 can indicate a willingness to user personal transport, such as scooters and bicycles (e.g., up to a predefined distance). Additionally or alternatively, the timing optimization engine 150 can query for this information while the user 197 is in transit. Given a current time of day, day of the week, and the route and direction of travel of the third-party transit means, the timing optimization engine 150 can infer an arrival location of the transit means and a final destination of the user 197 using the user's profile 112. In such examples, the timing optimization engine 150 can transmit a simple confirmation query providing the user 197 with the inferred information and asking the user 197 to confirm the arrival location, final destination, and/or transport mode preference.

Whether inferred or actively queried, when the arrival location of the third-party transit means, the final destinations, and the transport permissions or preferences are known for a cluster of the transiting users 197 (hereinafter “cluster data”), the timing optimization engine 150 can further receive transport provider information, such as the locations of transport providers (e.g., AVs, carpool drivers, and standard rideshare drivers), the status of each transport provider (e.g., on-trip, available, off-duty), the locations of high capacity distribution vehicles, their inventory of scooters and/or bicycles, and their current distribution schedules (hereinafter “provider data”). The timing optimization engine 150 can process the provider data and the cluster data to determine, for each transiting user 197, an optimal time to request transport such that the overall logical costs (e.g., driver wait times, traffic congestion, user wait times, etc.) at the arrival location are minimized.

In various examples, the timing optimization engine 150 can monitor transport supply conditions at each arrival location of the third-party transit means and perform timing optimizations for each cluster of transit users 197 disembarking at each arrival location of the third-party transit means. Accordingly, the timing optimization engine 150 can determine a total number of transiting users 197 that will disembark at a common arrival location. For each of these transiting users 197, the timing optimization engine 150 can determine a preferred mode of transport or multiple permitted modes of transport to transport each user 197 to a respective final destination. The timing optimization engine 150 can further determine each user's final destination and, in certain examples, the transport supply conditions for each mode of transport at the common arrival location. These supply conditions can correspond to a number of available personal transport vehicles at the arrival location, the number of awaiting or nearby transport vehicles, the ETAs of the available vehicles to the arrival location, and the like.

In various implementations, the transiting users 197 have the option of selecting from multiple transport options, such as a standard rideshare option, a luxury vehicle option, a carpool option, a walk-pool option, a high-capacity vehicle option, and personal transport options (e.g., shared scooters and/or bicycles). Once the transport preferences and final destinations of each transiting user 197 are known, the timing optimization engine 150 can monitor an ETA of the third-party transit means to the common arrival location, as provided by the transit monitor 140. For each transiting user 197, the timing optimization engine 150 can determine an optimal request time to transmit a ride request.

In various examples, the optimal request time can correspond to a specific time when the user 197 should transmit a transport request, and can be configured for each disembarking user 197 such that the wait times for the cluster of users 197 as a whole is minimized, as well as the wait times of the arriving transport providers to the arrival location. As an example, once the optimal request time is determined for a user 197, the timing optimization engine 150 can transmit a timing trigger to the computing device 195 of the user 197. In one aspect, the timing trigger can comprise a countdown to the optimal request time for that user 197. In variations, the timing optimization engine 150 can transmit a notification (e.g., a push notification) indicating the precise time to transmit the request. In such examples, the notification can further indicate the selected transport option for the user 197 (e.g., either selected by the user 197 or automatically selected by the computing system 100), and can comprise a selectable request button which the user 197 can select to automatically transmit the transport request.

For a cluster of arriving users 197, the timing optimization can account for each user's transport option selection (e.g., carpool, standard rideshare, luxury car, high capacity vehicle, etc.), the locations and ETAs of each of the available transport providers, the ETA of the transit means to the arrival location, and in some aspects, the locations of the users 197 within the transit means and the expected walking distance and/or time of the user 197 from a point of disembarking (e.g., the back of a train) to a pick-up area at which the user 197 is to rendezvous with a matched transport provider 190. In such an implementation, the timing optimization performed for this cluster of users 197 can comprise a predictive tool that seeks to maximize the pick-up flow at the arrival location in order to minimize wait times by drivers, minimize traffic congestion, minimize wait times of the arriving users 197, and as a result, maximize transport provider utility.

Accordingly, the timing optimization engine 150 can transmit a request trigger to each arriving user 197 well prior to the transit means arriving at the common arrival location. In various examples, each arriving user 197 may receive a unique request trigger that indicates an individualized, specific time for that user 197 to transmit a transport request.

In certain implementations, the request timing optimization engine 150 can automatically transmit the transport request for each disembarking user 197 at the optimal time determined for that user 197. According to such examples, the timing optimization engine 150 can transmit a confirmation to the computing device 195 of each user 197 that indicates the submitted transport request, the selected transport option, and/or ETA information of a matched transport provider to a pick-up area of the arrival location. Furthermore, in such examples, the computing system 100 can act as a request timing service separate from the on-demand transport coordination system that transmits transport instructions and invitations to available transport providers 190 and that ultimately matches the users 197 with the transport providers 190.

Computing Device

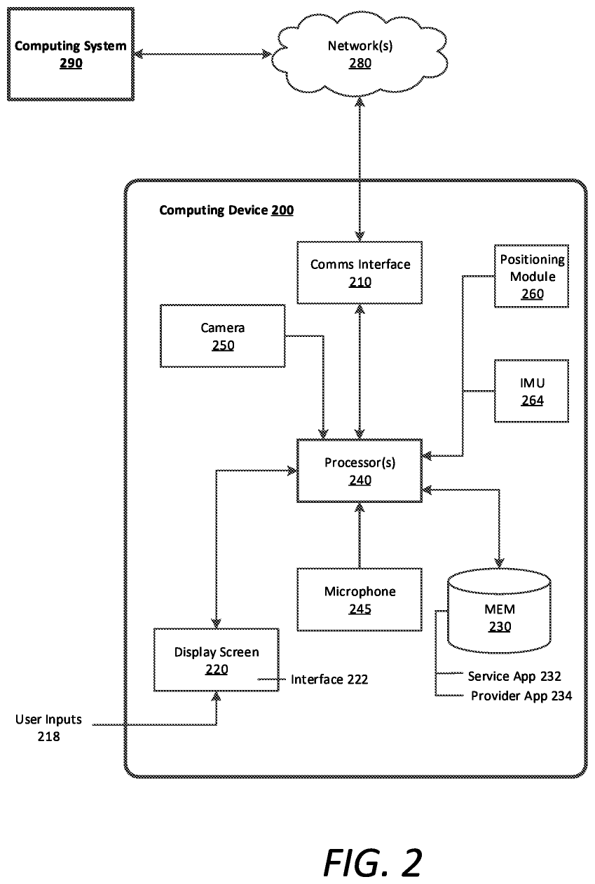

FIG. 2 is a block diagram illustrating an example computing device executing one or more service applications for communicating with a computing system, according to examples described herein. In many implementations, the computing device 200 can comprise a mobile computing device, such as a smartphone, tablet computer, laptop computer, VR or AR headset device, and the like. As such, the computing device 200 can include telephony features such as a microphone 245, a camera 250, and a communication interface 210 to communicate with external entities using any number of wireless communication protocols. The computing device 200 can further include a positioning module 260 and an inertial measurement unit 264 that includes one or more accelerometers, gyroscopes, or magnetometers. In certain aspects, the computing device 200 can store a designated on-demand transport service application 232 in a memory 230. In variations, the memory 230 can store additional applications executable by one or more processors 240 of the computing device 200, enabling access and interaction with one or more host servers over one or more networks 280.

The computing device 200 can be operated by a requesting user 197 through execution of the on-demand service application 232. The computing device 200 can further be operated by a transport provider 190 through execution of a provider application 234. For requesting user 197 implementations, the user can select the service application 232 via a user input on the display screen 220, which can cause the service application 232 to be executed by the processor 240. In response, a user application interface 222 can be generated on the display screen 220, which can display available transport options and enable the user to configure and submit a transport request.

For transport provider 190 implementations, the provider 190 can select the provider application 234 via a user input 218 on the display screen 220, which can cause the provider application 234 to be executed by the processor 240. In response, a provider application interface 222 can be generated on the display screen 220, which can enable the provider to receive transport invitations, and accept or decline these invitations. The provider app interface 222 can further enable the transport provider to select a current status (e.g., available, on-duty, on-break, on-trip, busy, unavailable, and the like).

As provided herein, the applications 232, 234 can enable a communication link with a computing system 290 over one or more networks 280, such as the computing system 100 as shown and described with respect to FIG. 1. The processor 240 can generate user interface features using content data received from the computing system 290 over network 280. Furthermore, as discussed herein, the applications 232, 234 can enable the computing system 290 to cause the generated interface 222 to be displayed on the display screen 220.

In various examples, the positioning module 260 can provide location data indicating the current location of the users and transport providers to the computing system 290 to, for example, enable the computing system 290 to coordinate on-demand transport and implement supply shaping techniques at arrival locations of transit modes, as described herein. In examples described herein, the computing system 290 can transmit content data to the communication interface 210 of the computing device 200 over the network(s) 280. The content data can cause the executing service application 232, 234 to display the respective interface 222 for each executing application 232, 234. Upon selection of a desired transport options by a requesting user, the service application 232 can cause the processor 240 to transmit a transport request to the computing system 290 to enable the computing system 290 to coordinate with transport providers to rendezvous with the users at a selected pickup area and time at the egress location of the transit means.

According to examples described herein, a transiting user 197 can execute the service application 232 while in-transit to an arrival location of a third-party transit means (e.g., a train). The computing system 290 can detect a launch trigger of the service application 232 from any number of users 197 using the same transit means. In certain examples, the computing system 290 can transmit a set of queries to each user 197 to determine a common arrival location of the transit means at which a cluster of users 197 will disembark, a preferred or permitted transport option for each user 197, and a final destination for each user 197. The computing system 190 may then receive transport provider information indicating the number of available transport providers for each option, an ETA of each transport provider to the arrival location, and the like. Based on the transport provider information, the ETA of the third-party transit means to the arrival location, and the transport options selected for each arriving user 197, the computing system 290 can perform a timing optimization to determine an optimal time for each user to transmit a transport request, as described herein.

Methodology

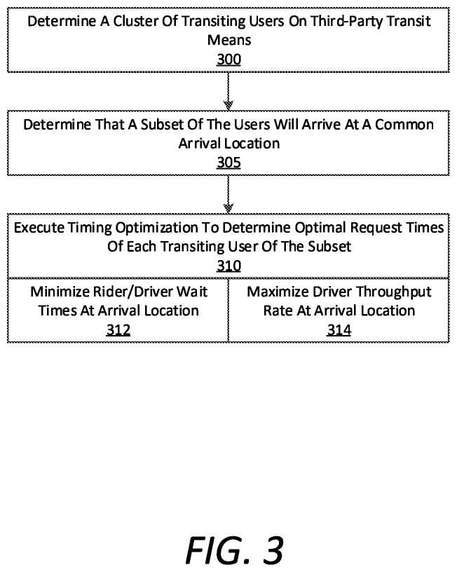

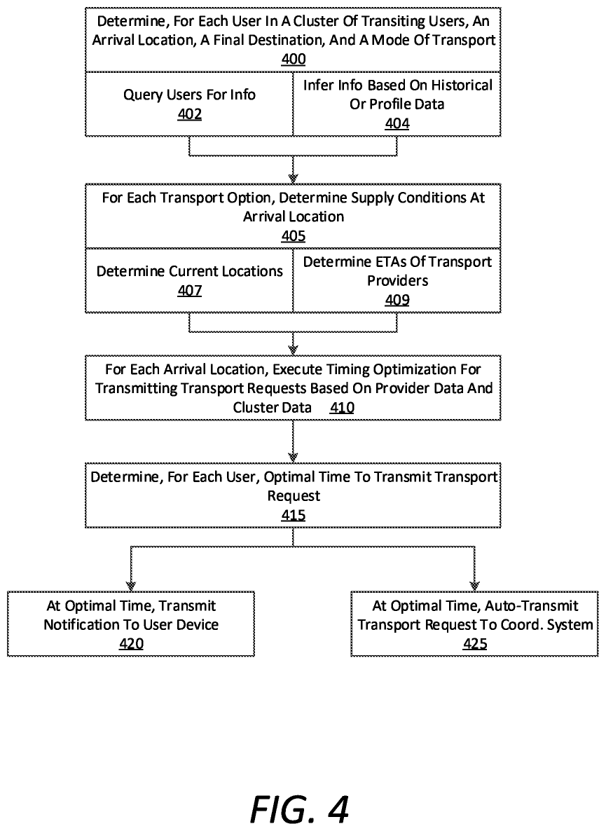

FIGS. 3 and 4 are flow charts describing example methods of executing timing optimizations for transport requests at transit egress areas, according to examples described herein. In the below description of FIGS. 3 and 4, reference may be made to reference characters representing various features of FIGS. 1 and 2. Furthermore, the processes described with respect to FIGS. 3 and 4 may be performed by an example computing system 100 as shown and described with respect to FIG. 1. Still further, the processes described with respect to FIGS. 3 and 4 need not be performed in any particular order, and may be combined with other steps shown and described herein.

Referring to FIG. 3, the computing system 100 can determine, based at least in part on location data from the computing devices 195 of a cluster of users, that the cluster of users is currently in transit on a third-party transit means (300). The computing system 100 can further determine that a subset of the cluster will arrive at a common arrival location of the third-party transit means. (305). The computing system 100 may then execute a timing optimization for the subset of users 197 to determine, for each user of the subset, an optimal time to transmit a transport request for an on-demand transport service at the common arrival location (310). In various examples, the computing system 100 can perform the timing optimization such that the driver and/or rider wait times at the arrival location is minimized (312). Additionally or alternatively, the computing system 100 can perform the timing optimization such that driver throughput rate at the arrival location is maximized (314).

FIG. 4 is a more detailed flow chart describing an example method of performing a timing optimization for a cluster of transiting riders arriving at a common transit egress location, according to various implementations. Referring to FIG. 4, the computing system can 100 determine, for each user 197 in a cluster of transiting users 197, a common arrival location of the third-party transit means, a final destination, and a preferred mode of transport (400). In various implementations, the computing system 100 can transmit queries to the users' computing devices 195 to determine this cluster data (402). Additionally or alternatively, the computing system 100 can determine at least some of the cluster data based on historical or profile data of the users 197 (404).

For each transport option, the computing system 100 can determine the supply conditions of that transport option at the arrival location (405). This provider data can comprise determining the current locations of each transport provider within a certain proximity of the arrival location (e.g., five miles) (407). Additionally, the computing system 100 can determine the estimated times of arrival (ETAs) of each transport provider to the arrival location (409). Furthermore, for each arrival location at which a cluster of users 197 is going to disembark, the computing system 100 can execute a timing optimization for transmitting transport requests based on the provider data and the cluster data (410).

In doing so, the computing system 100 determines an optimal time for each user to transmit a transport request to the transport coordination system (415). As described herein, these optimal times are configured such that wait times and/or overall costs for the arrival location are minimized. In other words, the optimal times for transmitting transport requests are configured such that when the cluster of users disembarks from the transit means, a sequence of transport providers arrives to maximize the throughput of the transport providers through a pick-up area of the arrival location. It is contemplated that by optimizing the timing of the transport requests, the computing system 100 can aid in minimizing traffic congestion and/or wait times of the users 197 and drivers at transit arrival locations.

In various implementations, the computing system 100 can transmit a notification to the computing device 195 of each user 197 at the determined optimal time for that user 197 (420). As described herein, the notification can indicate the optimal time to transmit the transport request. In variations or as an addition, the computing system 100 can automatically transmit the transport request for the user 197 at the determined optimal time for that user 197 (425). In either scenario, transport requests for each user 197 in the cluster can be transmitted while the users 197 are still in transit, which enables the transport coordination system to match the users with available transport providers, and ensure that the transport providers are en route to arrive at the arrival location at substantially the same time as the transiting users 197.

Hardware Diagram

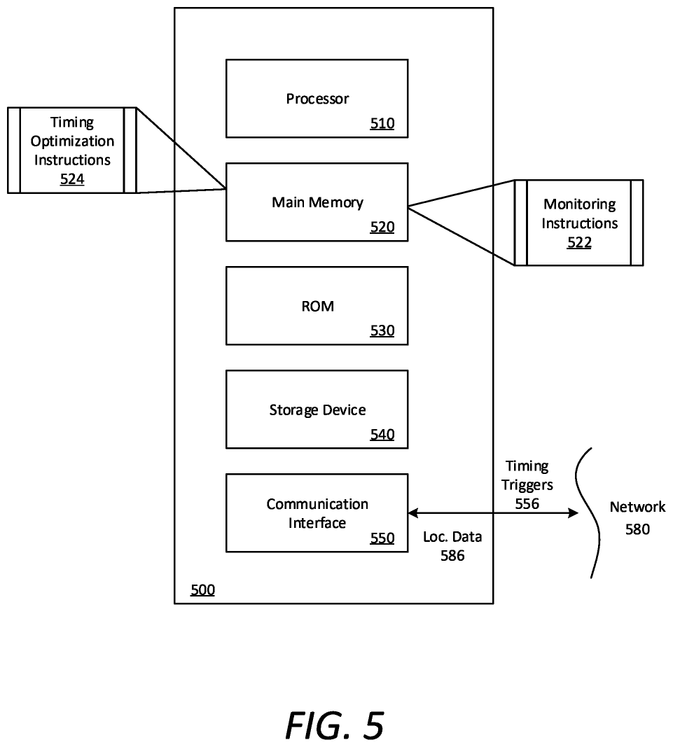

FIG. 5 is a block diagram that illustrates a computer system upon which examples described herein may be implemented. A computer system 500 can be implemented on, for example, a server or combination of servers. For example, the computer system 500 may be implemented as part of a network service, such as described in FIGS. 1 through 4. In the context of FIG. 1, the computer system 100 may be implemented using a computer system 500 such as described by FIG. 5. The computer system 100 may also be implemented using a combination of multiple computer systems as described in connection with FIG. 5.

In one implementation, the computer system 500 includes processing resources 510, a main memory 520, a read-only memory (ROM) 530, a storage device 540, and a communication interface 550. The computer system 500 includes at least one processor 510 for processing information stored in the main memory 520, such as provided by a random-access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or wired). Using the network link, the computer system 500 can communicate with one or more computing devices, one or more servers, one or more databases, and/or one or more self-driving vehicles. In accordance with examples, the computer system 500 receives requests from mobile computing devices of individual users. The executable instructions stored in the memory 530 can include transit monitoring instructions 522 and timing optimization instructions 524.

By way of example, the instructions and data stored in the memory 520 can be executed by the processor 510 to implement the functions of an example computing system 100 of FIG. 1. In various examples, the processor 510 can execute the monitoring instructions 528 to receive location data 586 from requesting users 197 and determine the ETA of a particular third-party transit means, such as a train or ferry. In certain implementations, the processor 510 executes the timing optimization instructions to determine optimal transport request times for each user 197, and transmitting timing triggers 556 for the transport requests at the optimal times.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system comprising:
a network communication interface to communicate, over one or more networks, with computing devices of requesting users and transport providers of a transport service;
one or more processors; and
a memory storing instructions that, when executed by the one or more processors, cause the computing system to:
determine, based at least in part on location data from the computing devices of a cluster of the requesting users, that the cluster of requesting users is currently in transit on a third-party transit means;
determine that a subset of the cluster will arrive at a common arrival location of the third-party transit means; and
execute a timing optimization for the subset to determine, for each requesting user of the subset, an optimal time to transmit a transport request for an on-demand transport service at the common arrival location.

2. The computing system of claim 1, wherein the network communication interface further communicates with a scheduling resource of the third-party transit means to determine an estimated time of arrival (ETA) of the third-party transit means to the common arrival location, and wherein the executed instructions cause the computing system to determine the optimal time for each requesting user of the subset based at least in part on the ETA of the third-party transit means.

3. The computing system of claim 1, wherein the executed instructions further cause the computing system to:
determine, for each requesting user of the subset while the requesting user is in-transit on the third-party transit means, that the requesting user intends to request transport at the common arrival location.

4. The computing system of claim 3, wherein the executed instructions further cause the computing system to:
determine, for each requesting user of the subset, a preferred transport option and a final destination.

5. The computing system of claim 4, wherein the executed instructions cause the computing system to determine the preferred transport options and the final destination for each requesting user of the subset by transmitting, over the one or more networks, a set of queries to the computing device of each requesting user of the subset, the set of queries prompting the requesting user to indicate or confirm the common arrival locations, the preferred transport option, and the final destination.

6. The computing system of claim 4, wherein the executed instructions cause the computing system to determine, for at least one of the requesting users of the subset, the preferred transport option and the final destination by performing a look-up in a user profile of the at least one requesting user, the user profile comprising historical utilization information of the on-demand transport service.

7. The computing system of claim 1, wherein the executed instructions further cause the computing system to:
for each requesting user of the subset, transmit, over the one or more networks, a notification to the computing device of the requesting user, the notification indicating the optimal time to transmit the transport request.

8. The computing system of claim 1, wherein the executed instructions further cause the computing system to:
for each requesting user of the subset, automatically transmit, over the one or more networks, the transport request for the requesting user at the optimal time of the requesting user.

9. The computing system of claim 1, wherein the third-party transit means comprises one of a bus, a train, a ferry, or a plane.

10. The computing system of claim 1, wherein the executed instructions cause the computing system to execute the timing optimization based on the subset of the cluster crossing a minimum rider threshold.

11. A non-transitory computer readable medium storing instructions that, when executed by one or more processors of a computing system, cause the computing system to:
communicate, over one or more networks, with computing devices of requesting users and transport providers of a transport service;
determine, based at least in part on location data from the computing devices of a cluster of the requesting users, that the cluster of requesting users is currently in transit on a third-party transit means;
determine that a subset of the cluster will arrive at a common arrival location of the third-party transit means; and
execute a timing optimization for the subset to determine, for each requesting user of the subset, an optimal time to transmit a transport request for an on-demand transport service at the common arrival location.

12. The non-transitory computer readable medium of claim 11, wherein the executed instructions cause the computing system to further communicate, over the one or more networks, with a scheduling resource of the third-party transit means to determine an estimated time of arrival (ETA) of the third-party transit means to the common arrival location, and wherein the executed instructions cause the computing system to determine the optimal time for each requesting user of the subset based at least in part on the ETA of the third-party transit means.

13. The non-transitory computer readable medium of claim 11, wherein the executed instructions further cause the computing system to:
determine, for each requesting user of the subset while the requesting user is in-transit on the third-party transit means, that the requesting user intends to request transport at the common arrival location.

14. The non-transitory computer readable medium of claim 13, wherein the executed instructions further cause the computing system to:
determine, for each requesting user of the subset, a preferred transport option and a final destination.

15. The non-transitory computer readable medium of claim 14, wherein the executed instructions cause the computing system to determine the preferred transport options and the final destination for each requesting user of the subset by transmitting, over the one or more networks, a set of queries to the computing device of each requesting user of the subset, the set of queries prompting the requesting user to indicate or confirm the common arrival locations, the preferred transport option, and the final destination.

16. The non-transitory computer readable medium of claim 14, wherein the executed instructions cause the computing system to determine, for at least one of the requesting users of the subset, the preferred transport option and the final destination by performing a look-up in a user profile of the at least one requesting user, the user profile comprising historical utilization information of the on-demand transport service.

17. The non-transitory computer readable medium of claim 11, wherein the executed instructions further cause the computing system to:
for each requesting user of the subset, transmit, over the one or more networks, a notification to the computing device of the requesting user, the notification indicating the optimal time to transmit the transport request.

18. The non-transitory computer readable medium of claim 11, wherein the executed instructions further cause the computing system to:
for each requesting user of the subset, automatically transmit, over the one or more networks, the transport request for the requesting user at the optimal time of the requesting user.

19. The non-transitory computer readable medium of claim 11, wherein the third-party transit means comprises one of a bus, a train, a ferry, or a plane.

20. A computer-implemented method of implementing an on-demand transport service, the method being performed by one or more processors and comprising:
communicating, over one or more networks, with computing devices of requesting users and transport providers of a transport service;
determining, based at least in part on location data from the computing devices of a cluster of the requesting users, that the cluster of requesting users is currently in transit on a third-party transit means;
determining that a subset of the cluster will arrive at a common arrival location of the third-party transit means; and
executing a timing optimization for the subset to determine, for each requesting user of the subset, an optimal time to transmit a transport request for an on-demand transport service at the common arrival location.
